(19) United States
(12) Patent Application Publication
(10) Pub. No.: US 2010/0315048 A1
(43) Pub. Date: Dec. 16, 2010

(54) VOLTAGE STEP-UP CIRCUIT

(75) Inventors: Luis De Sousa, Maisons Laffitte (FR); Jean-Baptiste Roux, Valence (FR); Larbi Bendani, Saint Ouen L'aumone (FR)

Correspondence Address: OSHA LIANG L.L.P., TWO HOUSTON CENTER, 909 FANNIN, SUITE 3500, HOUSTON, TX, 77010, US

(73) Assignee: VALEO SYSTEMES DE CONTROLE MOTEUR, Cergy Pontoise Cedex (FR)

(21) Appl. No.: 12/743,266

(22) PCT Filed: Nov. 20, 2008
(86) PCT No.: PCT/FR08/01622

§ 371 Date: Aug. 27, 2010

(30) Foreign Application Priority Data
Nov. 20, 2007 (FR) 0708144

(51) Int. Cl. G05F 1/10

(52) U.S. Cl. 323/234

(57) ABSTRACT

The present invention relates to a voltage step-up circuit (100). One particularly advantageous application of the invention is in the field of 12 V/42 V DC/DC power convertors supplied by the power system onboard a motor vehicle (12 V battery voltage). The circuit (100) according to the invention comprises a voltage source (S) having a first terminal (+BAT) and a second terminal, at least one inductor (Lb), the first terminal of which is connected to the first terminal (+BAT) of the voltage source (S), at least one diode (Db), the anode of which is connected to the second terminal of the inductor (Lb), at least one capacitor (Cb), the first terminal of which is connected to the cathode of the diode (Db), at least one current switch (Mb) connected between the second terminal of the inductor (Lb) and the second terminal of the voltage source (S), and a second current switch (M) connected between the second terminal of the capacitor (Cb) and the second terminal of the voltage source (S). The circuit (100) according to the invention further includes means (D) for allowing the current to flow from the second terminal of the capacitor (Cb) to the first terminal (+BAT) of the voltage source (S).

The present invention relates to a voltage step-up circuit. One particularly advantageous application of the invention lies in the field of 12 V/42 V DC/DC power converters powered by the onboard network of an automobile (12 V battery voltage) and providing the power supply for the power bridges in order to control the current of the electrical machines with variable inductance.

12 V/42 V DC/DC converters are thus often used as voltage source for H power bridges, also called single-phase or polyphase “four quadrant” bridges. These bridges are used notably to control the electromagnetic valve actuator current (“camless” system).

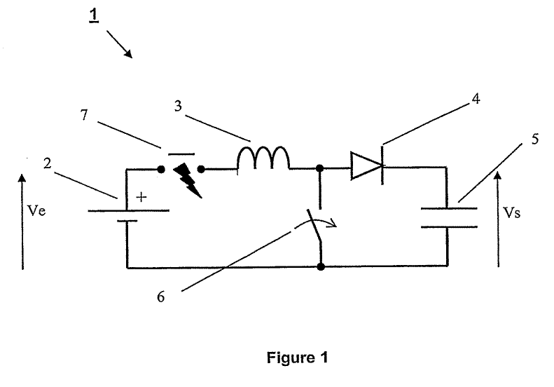

Such a DC/DC converter is implemented using a voltage step-up circuit. One example of a voltage step-up circuit 1, also called “boost” type circuit, is illustrated in FIG. 1.

The circuit 1 comprises
a voltage source 2 such as the voltage from the battery of an automobile comprising a first and a second terminals (in this case a +terminal and the ground),
an inductor 3, the first terminal of which is linked to the +terminal of the voltage source 2,
a diode 4, the anode of which is linked to the second terminal of the inductor 3,
a capacitor 5, the first terminal of which is linked to the cathode of the diode 4,
a current switch 6 such as a MOSFET field-effect transistor linked between the second terminal of the inductor 3 and the ground,
a second current switch 7 (which can be a MOSFET transistor or a relay-type electromechanical component) linked between the +terminal of the voltage source 2 and the first terminal of the inductor 3 (it will be noted that this second switch can also be linked between the second terminal of the capacitor 5 and the ground).

The operation of the “boost” circuit 1 can be divided into two distinct phases depending on the state of the switch 6:
an energy accumulation phase: when the switch 6 is closed (on state), this causes the current to increase in the inductor 3 and therefore a quantity of energy to be stored in the form of magnetic energy. The diode 4 is then blocked and the capacitor 5 is disconnected from the power supply.
When the switch 6 is open, the inductor 3 is then in series with the generator and its emf (electromotive force) is added to that of the generator (booster effect). The current passing through the inductor then passes through the diode 4 and the capacitor 5. The result is a transfer of the energy accumulated in the inductor 3 to the capacitor 5.

This discharge is possible only if the voltage Vs at the terminals of the capacitor 5 is greater than the voltage Ve (battery voltage). The output voltage Vs is then virtually continuous and its value depends on Ve and on the duty cycle α=τ/T of the pulsed control signal from the switch 6 in which τ is the high state time of the control signal in a period and T is the period of the control signal. This means that the charging current is controlled by PWM (pulse width modulation). In this case Vs=Ve/(1-α) and the output voltage is always greater than the input voltage (the duty cycle varying between 0 and 1) and increases with α.

The capacitor 5 is very often formed by a chemical capacitor which has its positive pole linked to the cathode of the diode 4. The use of chemical capacitors is often unavoidable in applications that require a large reserve of energy. In practice, said chemical capacitors have the best energy density.

However, the use of these chemical capacitors poses a number of problems.

Thus, chemical capacitors have the drawback of generating large leakage currents which can be a nuisance in an application which is notably powered by the battery of an automobile. The leakage currents may cause a deep discharge of the battery, if the appliance remains powered down for long enough. Such is the case, for example, with a converter connected to the 12 V battery of a vehicle in parking mode. It may then be necessary to disconnect the capacitors to reduce the leakage currents. Specifically, an electromagnetic valve system requires a converter to generate not only a power supply network suitable for the valve actuators, in the present case, a 42 V network, from the onboard network, but also, and above all, to decouple the 12 V onboard network from the 42 V auxiliary network. In effect, the control of the actuators generates a very high low-frequency harmonics ratio. In order to limit the current ripples on the onboard network and thus preserve the battery, the capacitance of the 42 V network must be increased. A high value capacitive bank is therefore necessary, which has leakage currents that are incompatible with the parking mode specifications.

One known solution for resolving this problem associated with the leakage currents consists in using a switch 7 to disconnect these capacitors. Thus, opening the switch in parking mode prevents any current leakage and therefore any risk of discharging the battery.

However, implementing this solution poses certain difficulties.

Thus, as mentioned above, controlling the current in the circuit 1 is possible only if the voltage Vs at the terminals of the capacitor 5 is greater than the voltage Ve. The circuit 1 cannot control the current when the output voltage is lower than the input voltage. This case is encountered on each power up (closure of the switch 7) when the output voltage Vs is zero because the reservoir capacitor 5 is discharged. The charge of the capacitor 5 generates a current that cannot be controlled by the circuit 1. The current inrush is limited only by the line resistors. The charging time is defined by the size of the capacitors and these line resistors. Upon power up, the output capacitor 5 is charged abruptly until the output voltage reaches a balance value close to the input voltage. In the case of a capacitor charge through a resistor, it is considered that, for a quantity of energy transferred, as much is dissipated. This energy is dissipated over a short duration. The powers involved can be destructive. Indeed, the inrush current can reach values that exceed the specifications of the components that are passed through by this current, notably those of the switch 7 which is used for powering up. In the case of a mechanical or electromechanical switch, the current inrush results in the destruction or the wear of the contacts under the effect of the electrical arc. In the case of a direct contact between the power supply cable and a voltage source with low internal resistance such as a battery for example, the arc can cause the metals in contact to melt and emit spatter. In the case of a solid-state switch of the MOSFET transistor type, the current inrush can cause its destruction or its premature ageing by violent local overheating, notably when the component has a low heat capacity.

The inrush current can also cause other nuisances such as the collapse of the voltage source if its internal resistance is too great.

It will be noted that, even if there is no power-up switch 7, the same drawbacks can be transposed to any other switch located in the loop travelled by the inrush current.

Solutions are known that can be used to limit this inrush current: the principle of these limiting circuits is to limit the current inrush by heat dissipation. A limiting circuit becomes all the more useful when the output capacity is high.

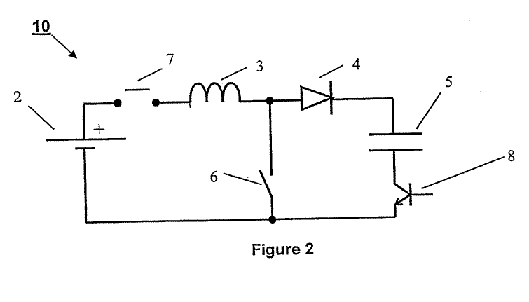

A first example of a limiting circuit 10 is illustrated in FIG. 2. The circuit 10 is identical to the circuit 1 of FIG. 1 (common components have the same reference numbers), except that it includes a transistor 8 mounted in series between the second terminal of the capacitor 5 and the ground. This transistor 8 can be a bipolar transistor or a field-effect transistor of MOSFET or JFET type. The solution involves controlling the charging current of the capacitor 5 by linear mode operation of the transistor 8. This transistor can also act as a switch (saturated mode) to isolate or connect the capacitor 5 to the ground after the limiting function has been activated. For high capacitance values, the number of transistors may be high, notably if the time allowed for precharging is short. A high number of transistors leads to a significant excess cost. In addition, the parallel-connection of transistors in linear mode increases the complexity of the circuit because the balancing of the currents is not natural.

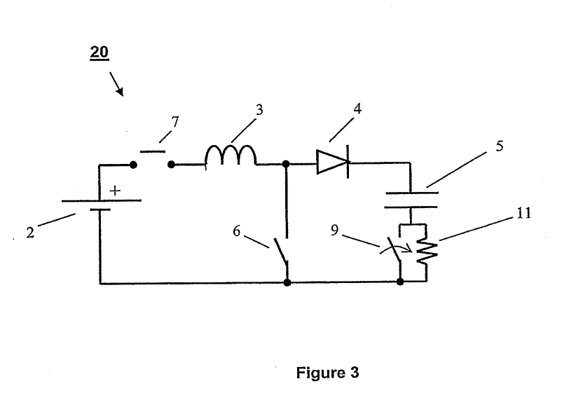

Another solution involves limiting the inrush current by a series resistor. This solution is illustrated by the circuit 20 represented in FIG. 3.

The circuit 20 is identical to the circuit 1 of FIG. 1 (the common components have the same reference numbers), except that it includes a switch 9 mounted in series between the second terminal of the capacitor 5 and the ground, and a resistor 11 mounted in parallel with the switch 9. The inrush current is then limited by the resistor 11. The switch 9 can be used to isolate or connect the capacitor with respect to the ground.

However, the solutions illustrated in FIGS. 2 and 3 also pose certain difficulties.

Thus, notably in the case of the control of electromagnetic valves, the delay for starting (i.e. the delay between the moment when the driver turns the ignition key and the moment when the system should be ready) is a relatively short delay, of the order of 300 ms in total. Moreover, during this delay, numerous other actions, other than the precharging of the capacitor, must be carried out (diagnostics, reset, starting up power supplies, etc): therefore, there is little time reserved for the precharging of the capacitor 5. Either of the solutions of FIG. 2 or 3 has the drawback of limiting the current by heat dissipation. In the case where a rapid precharging is necessary, the power to be dissipated is great and leads to circuits that are relatively bulky and costly in relation to the usage time of the function over the lifecycle of the product. To give an idea, if a precharge in 4.7 ms (RC value) is desired, an R=0.1 Ω resistor 10 and a capacitor 5 with a capacitance C=47 mF can be taken. By taking an input voltage value Ve of 10 V (the battery voltage is often slightly less than 12 V) and by estimating the maximum value of the inrush current at Ve/R, an inrush current of the order of 100 A is obtained, or a dissipated power of the order of 1000 W. Therefore, dissipated power is very great. Even if the resistor has a low value, such a configuration requires a power resistor of very large size. Only through-hole mount resistors can be used, and the use of SMC (surface-mount components) cannot be considered; it may even be necessary to use two resistors in parallel. It can therefore easily be seen that these solutions lead not only to a loss of space but also to a significant excess cost.

In this context, the aim of the present invention is to provide a voltage step-up circuit with which to economically provide a rapid precharging of the capacitive element while reducing the space occupied by the components forming said circuit.

To this end, the invention proposes a voltage step-up circuit comprising:
a voltage source comprising a first and a second terminals,
at least one inductor, the first terminal of which is linked to said first terminal of said voltage source,
at least one diode, the anode of which is linked to the second terminal of said inductor,
at least one capacitor, the first terminal of which is linked to the cathode of said diode,
at least one current switch linked between said second terminal of said inductor and said second terminal of said voltage source,
a second current switch linked between the second terminal of said capacitor and said second terminal of said voltage source,
   said circuit being characterized in that it comprises means for enabling the current to flow from said second terminal of said capacitor to said first terminal of said voltage source.

The term “capacitor” should be understood to mean any type of capacitive charge: it may be a single capacitor, but may also be a capacitive bank comprising a plurality of capacitors mounted in series or in parallel. Similarly, the term “inductor” covers a single inductor but also a plurality of inductors mounted in series or in parallel.

By virtue of the invention, the proposed configuration offers the advantage of not limiting the current by heat dissipation by using a structure that makes it possible to control the current. The addition of means to enable the current to flow from the second terminal of the capacitor (its negative pole in the case of a chemical capacitor) to the first terminal of the voltage source (the positive terminal of the battery in the case of a vehicle battery power supply) makes it possible to control the charging current of the capacitive bank. These means are typically formed by a diode. By linking the cathode of the capacitor to the battery rather than to the ground through this diode, the charging current originating from the demagnetization of the inductor is allowed to flow.

Moreover, apart from the losses that are usually found in a step-up circuit, this solution does not dissipate additional heat, unlike a limiting resistor or a linear mode transistor based current control. The circuit according to the invention makes it possible to do away with the use of power components incurring a significant excess cost.

Furthermore, this configuration does not alter the operation of the voltage step-up circuit and makes it possible to control the charging current by conventional PWM, and do so regardless of the state of charge of the capacitive bank. The second switch is used to disconnect (and reconnect) the capacitive element from (and to) the ground.

The system according to the invention can also have one or more of the characteristics hereinbelow, considered individually or according to all technically feasible combinations.

Particularly advantageously, said means for enabling the current to flow from said second terminal of said capacitor to said first terminal of said voltage source are formed by a second diode, the anode of which is linked to said second terminal of said capacitor and the cathode of which is linked to said first terminal of said voltage source.

The invention is particularly advantageously applicable in the case where said at least one capacitor is a chemical capacitor.

According to an advantageous embodiment, the circuit according to the invention comprises a second capacitor linked between the anode of said at least one diode and said second terminal of said voltage source.

According to another advantageous embodiment, the circuit according to the invention comprises:
n inductors Lbi, with i ranging from 1 to n and n being a natural integer greater than or equal to 2, each of the inductors Lbi having its first terminal linked to said first terminal of said voltage source,
n diodes Dbi, with i ranging from 1 to n, each of the diodes Dbi having its anode linked to the second terminal of said inductor Lbi,
n current switches Mbi, with i ranging from 1 to n, each of the switches Mbi being linked between said second terminal of said inductor Lbi and said second terminal of said voltage source and each of the switches Mbi being controlled so that it is closed while the other switches are open,
   said at least one capacitor having its first terminal linked to the cathode of each of said diodes Dbi.

Advantageously, said voltage source is formed by the battery of an automobile.

Advantageously, the circuit according to the invention converts a 12 V DC voltage into a 42 V DC voltage.

Another subject of the present invention is the use of the circuit according to the invention to power an H bridge in order to control the current in an electrical control member, the voltage at the terminals of said at least one capacitor forming the power supply voltage.

Advantageously, the electrical member is included in an actuator provided with an actuated part, said electrical member controlling the movement of said actuated part.

Preferentially, said actuator is an actuator for electromagnetic valves.

Other features and benefits of the invention will become clearly apparent from the description which is given thereof hereinbelow, as an indication and in a nonlimiting manner, with reference to the appended figures, in which:

FIG. 1 is a diagrammatic representation of the electronic structure of a voltage step-up circuit illustrating the state of the art;

FIGS. 2 and 3 each illustrate a voltage step-up circuit incorporating a current limiter circuit according to the state of the art;

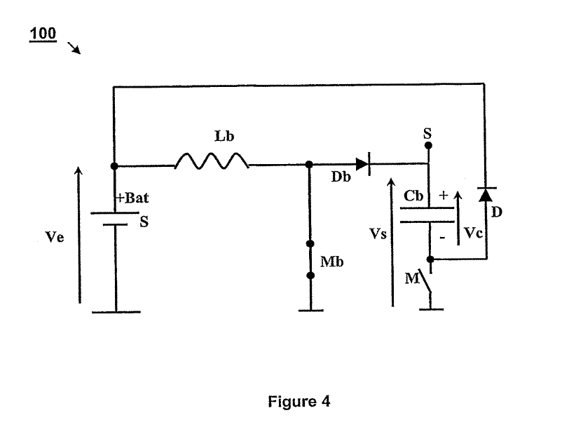

FIG. 4 represents a voltage step-up circuit according to the invention;

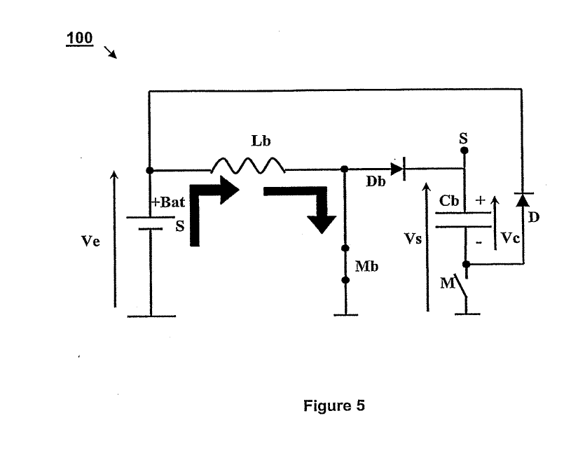

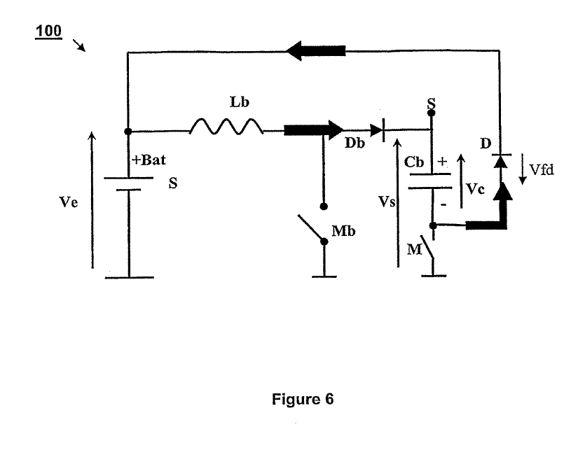

FIGS. 5 and 6 illustrate the current limiter mode operation of the voltage step-up circuit according to the invention as represented in FIG. 4;

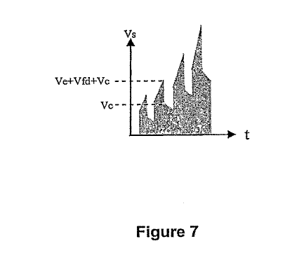

FIG. 7 represents the trend of the potential Vs as a function of time during the capacitor precharging phase;

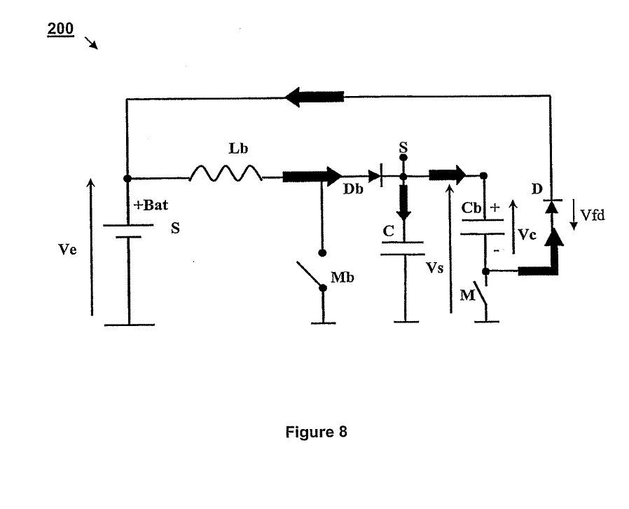

FIG. 8 represents a voltage step-up circuit according to a second embodiment of the invention;

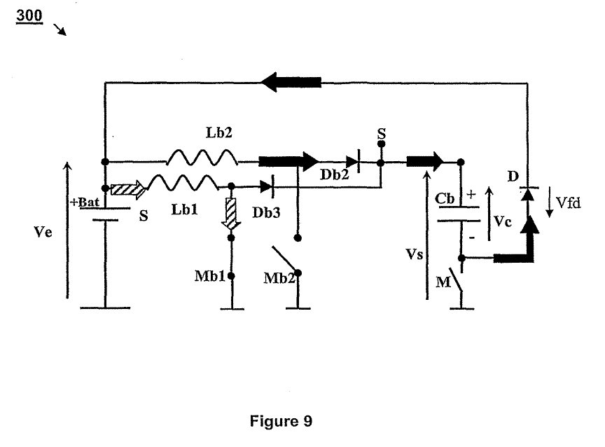

FIG. 9 represents a voltage step-up circuit according to a third embodiment of the invention.

In all the figures, the common elements are given the same reference numbers.

FIGS. 1 to 3 have already been described with reference to the state of the art.

FIG. 4 represents a voltage step-up circuit 100 according to the invention.

The circuit 100 comprises:
a voltage source S such as the voltage from the battery of an automobile comprising a first and a second terminals (in this case, a +BAT terminal and the ground) delivering an input voltage Ve,
an inductor Lb, the first terminal of which is linked to the +BAT terminal of the voltage source S,
a diode Db, the anode of which is linked to the second terminal of the inductor 3,
a capacitor Cb, of chemical capacitor type, the first terminal (positive pole) of which is linked to the cathode of the diode Db (it will be noted that this capacitor Cb is not usually singular, and is often formed by a capacitive bank),
a current switch Mb, such as a MOSFET field-effect transistor linked between the second terminal of the inductor Lb and the ground,
a second current switch M (which may be a MOSFET transistor or a relay-type electromechanical component) linked between the second terminal (negative pole) of the capacitor Cb and the ground,
a second diode D, the anode of which is linked to the negative pole of the capacitor Cb and the cathode of which is linked to the +BAT terminal.

The switch Mb is controlled by a PWM-type control that has a duty cycle a with a switching period T.

During the precharging of the capacitor Cb with limiting of the inrush current, the switch M is open so that the second terminal (negative pole) of the capacitor Cb is not linked to the ground but to the battery.

The operation of the circuit 100 in inrush current limiter mode is illustrated with reference to FIGS. 5 and 6. In each of these figures, the bold arrows indicate the direction of the current.

As illustrated in FIG. 5, when the switch Mb conducts (the control signal of Mb varying from 0 to αT), the inductor Lb is magnetized and therefore stores energy that it releases when the switch Mb is opened.

After the opening of the switch Mb (the control signal of Mb varying from αT to T), as illustrated in FIG. 6, the diodes Db and D conduct in turn and the energy is thus transferred from the inductor Lb to the capacitor Cb.

When the switch Mb once again conducts, the diodes are blocked and the capacitor cannot release its energy. Said energy is thus accumulated in each switching period T.

The addition of the second diode D and the disconnection of the negative pole of the capacitor Cb from the ground make it possible to control the charging current of the capacitive bank Cb. By linking the cathode of the capacitor Cb to the battery rather than to the ground through this switch, the charging current originating from the demagnetization of the inductor Lb is allowed to flow. This configuration does not alter the operation of the circuit 100 in voltage step-up mode and makes it possible to control the charging current by conventional PWM and do so regardless of the state of charge of the capacitive bank Cb.

Apart from the losses that are usually found in a converter, this solution does not dissipate additional heat, unlike a limiting resistor or a linear mode transistor based current control.

It will be noted that, at the outset, the switch M is open to obtain a precharging without inrush current (i.e. with controlled current) of the capacitor Cb. When the voltage Vc at the terminals of the capacitor Cb is equal to Ve (or even slightly greater to avoid any inrush current) M can be closed for operation as a voltage step-up circuit.

It will also be noted that the potential Vs (potential of the point S corresponding to the positive pole of the capacitor Cb relative to the ground) is not continuous during the precharging phase of the capacitor Cb. FIG. 7 illustrates this phenomenon by representing the voltage Vs as a function of time.

The potential Vs is switched (chopped) at the frequency of the PWM (of the order of 70 kHz in the case of the application relating to electromagnetic valves). In practice, when the switch Mb conducts, the diodes Db and D are blocked which sets the potential Vs at a voltage that varies between 0 and Vc. When the switch Mb is open, the diodes Db and D conduct which sets the potential Vs at Ve+Vfd+Vc, in which Vfd represents the voltage drop at the terminals of the diode D.

In applications in which the voltage Vs has to exhibit as few discontinuities as possible during the precharging phase of the capacitor, two solutions are illustrated in FIGS. 8 and 9.

FIG. 8 thus represents a voltage step-up circuit 200 according to a second embodiment of the invention that obviates the Vs discontinuity problem.

The circuit 200 is identical to the circuit 100 of FIG. 4, except that it includes an additional capacitor C linked between the anode of the diode Db and the ground. The value of the voltage at the terminals of this capacitor is therefore equal to the value of the potential Vs.

This capacitor C is a capacitor with low leakage current and low value (low capacitance “film” or ceramic type capacitors can be used). The capacitor C is connected between the ground and the output S to maintain the potential Vs when the switch Mb conducts. This capacitor C is permanently connected, so it is initially charged at the battery voltage (allowing for voltage drops). When the switch Mb conducts, the potential Vs is maintained at the charging voltage of the capacitor C. The capacitor C supplies the current for a possible load connected to the output. When the switch Mb is open, the diodes Db and D conduct and the current charges not only this capacitor C but also the capacitive bank Cb. The voltage at the terminals of C follows the voltage imposed by the capacitive bank Cb. Their ratings obviously depend on the load connected to the output on starting up.

FIG. 9 represents a voltage step-up circuit 300 according to a third embodiment of the invention that also obviates the Vs discontinuity problem.

Unlike the circuits 100 and 200 of FIGS. 4 and 8 which are single-cell circuits, the circuit 300 is a multicell circuit; in other words, this circuit 300 comprises n cells, each consisting of an inductor-diode-switch triplet (Lbi, Dbi, Mbi) (with i ranging from 1 to n, n being a natural integer strictly greater than 1). In the example of FIG. 9, n is equal to 2.

Each of the inductors Lbi has its first terminal linked to the +BAT terminal.

Each of the diodes Dbi has its anode linked to the second terminal of the inductor Lbi.

Each of the switches Mbi is linked between the second terminal of the inductor Lbi and the ground.

The capacitor Cb to be precharged has its first terminal (positive pole) linked to the cathode of each of the diodes Dbi.

Like the circuits 100 and 200, the circuit 300 comprises:
a current switch M linked between the negative pole of the capacitor Cb and the ground,
a diode D, the anode of which is linked to the negative pole of the capacitor Cb and the cathode of which is linked to the +BAT terminal.

There are therefore, in this case, several cells in parallel forming several step-up circuits. These cells are not synchronized so that the various switches Mbi do not close together (they each close in turn). This type of multicell configuration reduces the ripples on the charging current of the capacitor Cb (obviously, there must be sufficient cells to guarantee charging continuity for the capacitor Cb; i.e. n is often greater than 2). The advantage of a multicell configuration over a single cell is that it considerably reduces the current ripples (to obtain an identical ripple with a single-cell system, a very high value inductor would be needed) and distributes the power.

The phase difference between the cells ensures that at least one of the diodes Dbi is conducting at each instant. Therefore, the potential Vs is maintained at the value Ve+Vfd+Vc, in which Vfd represents the voltage drop at the terminals of the diode D. In the example shown in FIG. 9, the switch Mb1 is closed (therefore the switch Mb2 is open) and the diode Db2 is conducting. The respectively hatched and bold arrows indicate the two possible paths of the current depending on whether the current phase is the magnetization phase of the inductor Lb1 or the precharging phase of the capacitor Cb.

Obviously, the invention is not limited to the embodiment that has just been described.

Notably, the invention has been more particularly described in the case of use of a diode making it possible to link the foot of the capacitor to the +BAT terminal, but other means enabling the current to flow from the second terminal of the capacitor to the +BAT terminal can also be used; it is thus possible to use a switch in series between the negative pole of the capacitor and the +BAT terminal, this switch being closed at the moment when the switch Mb is opened.

Similarly, the embodiments described implement MOSFET transistors used as switches, but other types of transistors (IGBT for example) can also be used without departing from the framework of the invention.

Finally, any means can be replaced by an equivalent means.

1. A voltage step-up circuit comprising:
a voltage source comprising a first terminal and a second terminal;
at least one inductor, wherein a first terminal of the inductor is linked to said first terminal of said voltage source;
at least one first diode, wherein an anode of the at least one first diode is linked to a second terminal of said inductor;
at least one first capacitor, wherein a first terminal of the at least one first capacitor is linked to a cathode of said first diode;
at least one first current switch linked between said second terminal of said inductor and said second terminal of said voltage source;
a second current switch linked between a second terminal of said capacitor and said second terminal of said voltage source; and
means for enabling a current to flow from said second terminal of said capacitor to said first terminal of said voltage source.

2. The voltage step-up circuit as claimed in claim 1, wherein said means for enabling the current to flow from said second terminal of said capacitor to said first terminal of said voltage source are formed by a second diode, wherein an anode of the second diode is linked to said second terminal of said capacitor and a cathode of the second diode is linked to said first terminal of said voltage source.

3. The voltage step-up circuit as claimed in claim 1, wherein said at least one first capacitor is a chemical capacitor.

4. The voltage step-up circuit as claimed in claim 1, further comprising a second capacitor linked between the anode of said at least one first diode and said second terminal of said voltage source.

5. The voltage step-up circuit as claimed in claim 1, further comprising:
n inductors Lbi, with i ranging from 1 to n and n being a natural integer greater than or equal to 2, each of the inductors Lbi having a first terminal linked to said first terminal of said voltage source;
n diodes Dbi, with i ranging from 1 to n, each of the diodes Dbi having an anode linked to a second terminal of a corresponding inductor Lbi;
n current switches Mbi, with i ranging from 1 to n, each of the current switches Mbi being linked between said second terminal of said corresponding inductor Lbi and said second terminal of said voltage source, and each of the current switches Mbi being controlled so that each current switch is closed while the other switches are open;
said at least one first capacitor having the first terminal of the at least one first capacitor linked to a cathode of each of said n diodes Dbi.

6. The voltage step-up circuit as claimed in claim 1, wherein said voltage source is formed by the battery of an automobile.

7. The voltage step-up circuit as claimed in claim 6, wherein the voltage step-up circuit is configured to convert 12 V DC voltage into a 42 V DC voltage.

8. The voltage step-up circuit as claimed in claim 1, wherein the circuit is used to power an H bridge in order to control the current in an electrical control member, the voltage at the first and second terminals of said at least one first capacitor forming the power supply voltage.

9. The voltage step-up circuit as claimed in claim 8, wherein the electrical control member is included in an actuator provided with an actuated part, said electrical control member controlling the movement of said actuated part.

10. The voltage step-up circuit as claimed in claim 9, wherein said actuator is for electromagnetic valves.
